(19) United States
(12) Patent Application Publication
(10) Pub. No.: US 2023/0316128 A1
(43) Pub. Date: Oct. 5, 2023

(54) GRAPH PATTERN INFERENCE

(71) Applicant: BenevolentAI Technology Limited, London (GB)

(72) Inventors: Rachel HODOS, New York, NY (US); Joss BRIODY, Sevenoaks (GB); David APONTE, London (GB); Dane Sterling CORNEIL, London (GB); Daniel Paul SMITH, London (GB)

(21) Appl. No.: 18/007,391

(22) PCT Filed: Jul. 21, 2021
(86) PCT No.: PCT/GB2021/051868

§ 371 Date: Jan. 30, 2023

Related U.S. Application Data
(60) Provisional application No. 63/058,845, filed on Jul. 30, 2020.

(51) Int. Cl. G06N 20/00; G06N 5/025

(52) U.S. Cl. CPC G06N 20/00; G06N 5/025

(57) ABSTRACT

A computer-implemented method of querying a graph to assess relationships amongst graph nodes comprises determining a query node on the graph, identifying one or more target nodes on the graph in relation to the query node based on a set of connectivity patterns; generating graph-based statistics for each target node of the one or more target nodes, wherein the graph-based statistics are extracted for subgraphs associated with each target node and the query node; and assessing the graph-based statistics of each target node to determine predicted relationships between the one or more target nodes and the query node.

The present application relates to a system, apparatus and method(s) for querying a graph data structure and extracting new relationships or inferences from the graph data structure in an automated manner.

### BACKGROUND

With their increased prevalence, knowledge graphs or more generally graphs are becoming a popular data structure for analysing multi-dimensional data. Data can be represented on the graphs as nodes and edges. Nodes of a knowledge graph may be entities while edges represent relationships amongst the entities. These entities and relationships form patterns. The patterns can be assessed to derive new relationships or inferences. In the biomedical context, a causal relationship between the upregulation of a gene and a target disease can be identified through inferences to the extent that the inferences may further predict potential drugs for treating the disease. Analysing biomedical data in the form of graphs has therefore gained increasing popularity, due to the natural representation of heterogeneous data and the ability to construct interpretable hypotheses.

Approaches that utilise graph data structure to identify relationships amongst the nodes exist by relying on statistics of the nodes and edges. Many of these approaches are applicable in the field of telecom to process and analyse data. Some of these approaches examine the connectivity of a graph to predict relationships, or in certain case applying a procedure such as template-matching to identify inferences. Nevertheless, results obtained from these approaches remain inadequate and tend to lack sufficient specificity and sensitivity needed for accurately predicting the relationship of biological entities. That is, significant false positive and false negative predictions of targets inevitability produce unverifiable relationships between biomedical entities. In turn, significant iterations of curating the predicted results are required even with the current approaches.

There is a desire for a more efficient and robust graph pattern inference tool for extracting new relationships or inferences from a graph data structure while addressing the drawbacks of existing approaches. The herein described computer-implemented method, system, computer-readable medium and/or scaffold query tool will not only drive performance of individual queries, but also reduce the time required for hypothesis generation, enabling more rapid iteration through identifying potential patterns in the graph data structure. The discovery of new patterns could generate valuable hypotheses and provide broad insights into the nature of the relationships captured in the processed biomedical data. This will directly impact hypothesis generation of potential drug targets that are likely to be both viable and unprecedented.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

The present disclosure provides a scaffold query tool configured to query and extract relationships amongst the data by locating a query node in a knowledge graph (such as a disease node) and any potentially related nodes (target nodes) based on some pre-specified patterns of connectivity in the graph. The scaffold query tool can extract graph-based statistics describing each target node's connectivity to the query node, to use as inputs to an analysis component. The analysis component processes these inputs and provides scores of likelihood (or confidence) of specified relations using the analysis component. As an option,

classification or regression. The ML model may be trained using annotated data, e.g. of diseases and genes that are known to be related or derived from a dataset of existing relationships. As another option, patterns of connectivity in the graph may include hop-length restrictions, and/or paths with specific hop node or relationship types. The hop nodes can be restricted to specific types/identities of hop nodes.

In a first aspect, the present disclosure provides a computer-implemented method of querying a graph to assess relationships amongst graph nodes comprising: determining a query node on the graph; identifying one or more target nodes on the graph in relation to the query node based on a set of connectivity patterns; generating graph-based statistics for each target node of the one or more target nodes, wherein the graph-based statistics are extracted for subgraphs associated with each target node and the query node; and assessing the graph-based statistics of each target node to determine predicted relationships between the one or more target nodes and the query node.

In a second aspect, the present disclosure provides a system for querying a graph to assess relationships amongst the graph nodes, the system comprising: an identification module configured to identify one or more target nodes in relation to a query node based on a set of connectivity patterns; a processing module configured to generate a graph-based statistics for each target node of the one or more target nodes, wherein the graph-based statistics are extracted for subgraph associated with each target node and the query node; and an evaluation module configured to assess the graph-based statistics of each target node to determine predicted relationships between the one or more target nodes and the query node.

In a third aspect, the present disclosure provides a scaffold query tool for querying a graph to assess relationships amongst the graph nodes, the scaffold query tool comprising: an input component configured to receive the graph, and a query node on the graph and a set of connectivity patterns; a query component configured to identify one or more target nodes on the graph in relation to the query node based on a set of connectivity patterns an extraction component configured to extract graph-based statistics of a subgraph associated with each target node and the query node; and an analysis component configured to assess the graph-based statistics to determine predicted relationships between the one or more target nodes and the query node.

The methods described herein may be performed by software in machine-readable form on a tangible storage medium e.g. in the form of a computer program comprising computer program code means adapted to perform all the steps of any of the methods described herein when the program is run on a computer and where the computer program may be embodied on a computer-readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1a is a flow diagram illustrating an example of a process for querying a knowledge graph according to the invention;

FIG. 1b is a flow diagram illustrating another example of a process for querying a knowledge graph according to the invention;

FIG. 2 is a schematic diagram illustrating an example of a gene queried based on connectivity patterns according to the invention;

FIG. 3 is a schematic diagram illustrating an example of extracted graph-based statistics as inputs to an analysis component to be scored according to the invention;

FIG. 4 is a schematic diagram of an example knowledge graph or subgraph that may be used by the process of FIG. 1a or 1b;

FIG. 5 is a block diagram of a computer suitable for implementing embodiments of the invention.

Common reference numerals are used throughout the figures to indicate similar features.

### DETAILED DESCRIPTION

Embodiments of the present invention are described below by way of example only. These examples represent the suitable modes of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Herein describes a method, system, computer medium or a query tool for interacting with a graph by extracting information about the likelihood of two graph entities being causally or functionally related to each other. In the context of biomedical research, the method may be used in order to determine likely relationships between (for example) a specific disease, and genes that may be responsible for it. In particular, the invention allows the prioritisation of specific patterns—for example, of connectivity—within a graph in order to favour the most likely (i.e. ‘realistic’) inferred relationships.

More specifically, once a query node is determined on the graph, the method or tool identifies target nodes on the graph in relation to the query node based on a set of connectivity patterns. For each of the identified target nodes and the query node, graph-based statistics may be extracted for the associated subgraph. The extracted graph-based statistics may be used to determine whether a relationship, between each of the target nodes and the query node, is considered likely or a likely relationship exist by applying an ML model and/or rule-based model described in the sections below.

The above-described method or tool applies a combination of hop node categorisation, connectivity analysis of graph nodes, and graph-based statistics as inputs to an ML model for scoring and inferring direct relationships between query and target nodes. Accuracy of prediction is thereby significantly improved by at least this combined application.

ML models(s), predictive algorithms and/or techniques may be used to generate a trained model such as, without limitation, for example one or more trained ML models or classifiers based on input data referred to as training data associated with ‘known’ entities and/or entity types and/or relationships therebetween derived from large scale datasets (e.g. a corpus or set of text/documents or unstructured data). The input data may also include graph-based statistics as described in more detail in the following sections. With correctly annotated training datasets in such fields as chem(o)informatics and bioinformatics, techniques can be used to generate further trained ML models, classifiers, and/or analytical models for use in downstream processes such as, by way of example but not limited to, drug discovery, identification, and optimisation and other related biomedical products, treatment, analysis and/or modelling in the informatics, chem(o)informatics and/or bioinformatics fields. The term ML model is used herein to refer to any type of model, algorithm or classifier that is generated using a training data set and one or more ML techniques/algorithms and the like.

Examples of ML model/technique(s), structure(s) or algorithm(s) for generating a trained model that may be used by the invention as described herein may include or be based on, by way of example only but is not limited to, one or more of: any ML technique or algorithm/method that can be used to generate a trained model based on a labelled and/or unlabelled training datasets; one or more supervised ML techniques; semi-supervised ML techniques; unsupervised ML techniques; linear and/or non-linear ML techniques; ML techniques associated with classification; ML techniques associated with regression and the like and/or combinations thereof. Some examples of ML techniques/model structures may include or be based on, by way of example only but is not limited to, one or more of active learning, multitask learning, transfer learning, neural message parsing, one-shot learning, dimensionality reduction, decision tree learning, association rule learning, similarity learning, data mining algorithms/methods, artificial neural networks (NNs), autoencoder/decoder structures, deep NNs, deep learning, deep learning ANNs, inductive logic programming, support vector machines (SVMs), sparse dictionary learning, clustering, Bayesian networks, reinforcement learning, representation learning, similarity and metric learning, sparse dictionary learning, genetic algorithms, rule-based machine learning, learning classifier systems, and/or one or more combinations thereof and the like.

A knowledge graph and/or entity-entity graph may comprise or represent a graph data structure including a plurality of entity nodes in which each entity node is connected to one or more entity nodes of the plurality of entity nodes by one or more corresponding relationship edges, in which each relationship edge includes data representative of a relationship between a pair of entities. The term knowledge graph, entity-entity graph, entity-entity knowledge graph, graph, or graph dataset may be used interchangeably throughout this disclosure.

An entity may comprise or represent any portion of information or a fact that has a relationship with another portion of information or another fact. For example, in the biological, chem(o)informatics or bioinformatics space(s) an entity may comprise or represent a biological entity such as, by way of example only but is not limited to, a disease, gene, protein, compound, chemical, drug, biological pathway, biological process, anatomical region or entity, tissue, cell-line, or cell type, or any other biological or biomedical entity and the like. In another example, entities may comprise a set of patents, literature, citations or a set of clinical trials that are related to a disease or a class of diseases. In another example, in the data informatics fields and the like, an entity may comprise or represent an entity associated with, by way of example but not limited to, news, entertainment, sports, games, family members, social networks and/or groups, emails, transport networks, the Internet, Wikipedia pages, documents in a library, published patents, databases of facts and/or information, and/or any other information or portions of information or facts that may be related to other information or portions of information or facts and the like. Entities and relationships may be extracted from a corpus of information such as, by way of example but is not limited to, a corpus of text, literature, documents, web-pages; a plurality of sources (e.g. PubMed, MEDLINE, Wikipedia); distributed sources such as the Internet and/or web-pages, white papers and the like; a database of facts and/or relationships; and/or expert knowledge base systems and the like; or any other system storing or capable of retrieving portions of information or facts (e.g. entities) that may be related to (e.g. relationships) other information or portions of information or facts (e.g. other entities) and the like; and/or any other data source and/or content from which entities, entity types and relationships of interest may be extracted.

For example, in the biological, chem(o)informatics or bioinformatics space(s), a knowledge graph may be formed from a plurality of entities in which each entity may represent a biological entity from the group of: from the disease, gene, protein, compound, chemical, drug, biological pathway, biological process, anatomical region or entity, tissue, cell-line, or cell type, clinical trials, any other biological or biomedical entity and the like. Each of the plurality of entities may have a relationship with another one or more entities of the plurality of entities or itself. Thus, a knowledge graph or an entity-entity graph may be formed with entity nodes that include data representative of the entities and relationship edges connecting entities, and further include data representative of the relations/relationships between the entities. The knowledge graph may include a mixture of different entities with data representative of different relationships therebetween, and/or may include a homogenous set of entities with relationships therebetween.

Although details of the present disclosure may be described, by way of example only but are not limited to, with respect to biological, chem(o)informatics or bioinformatics entities, knowledge or entity-entity graphs and the like it is to be appreciated by the skilled person that the details of the present disclosure are applicable as the application demands to any other type of entity, information, data informatics fields and the like. For simplicity, the following describes a knowledge graph based on, for example, but is not limited to, gene and disease entities. Another example would be in the domain of online retail, where relationships between customers and products are mapped onto a graph data structure as edges.

A set of connectivity patterns may include one or more pre-specified patterns or scaffolds that comprise a query node along with a set of intermediate nodes and relationship types and/or a user-specified list of allowable hop nodes. Each connectivity pattern may be orthogonal/independent in relation to one another. A set or an ensemble of such patterns may yield an aggregate query or prediction of target nodes. Applying the set of connectivity patterns, at least one target node and edges leading to the target node may be identifiable within the knowledge graph.

A hop node may be an intermediate node on the knowledge graph to which the relationship between a query node and a target node traverse. The hop node may comprise various types in the context of a connectivity pattern. Some examples of a hop node type may be Pathway, Biological Process, Gene, and Disease. Categories of relationships may be associated with one or more hop node types for deriving the connectivity pattern. Examples of hop node types and their associated relationship are further described in the following sections.

Graph-based statistics are quantitative descriptors of the nodes and edges in the context of the graph or subgraph. The statistics may comprise various combinations of or derive from these quantitative assessments. These statistics may be based on all or some of the connections within the subgraph, e.g. ranging from a single path to a combination of paths. In most cases, graph-based statistics pertain to multiple paths from the query node to the target node form a subgraph. The subgraph comprises, in general, a subset of nodes and edges of the knowledge graph. A particular subgraph is associated with a pair of query and target nodes. The subgraph for multiple pairs of query and target nodes may overlap. The graph-based statistics of that subgraph may be further constrained for the assessment by the analysis component. These constraints are based on the type of model used during the assessment. Examples of these graph-based statistics are described in the following sections.

Hop-length represents the number/count of hops between the query and target node traversing one or more types of hop nodes. A hop-length of two may be shown as having two (a first and a second) hops with at least one hop node between the first and second hops. That is, a connectivity pattern may restrict the hop-length in relation to the types of hop nodes selected. A type of hop node or hop node type may comprise one or more intermediate nodes under the type that are connected in relation to certain classification predetermined based on some shared characteristics. These shared characteristics may be inferred or derived based on a set of data associated with the entities of the knowledge graph.

A relationship type or edge type defines the subset of edges that would be considered in a given part of the connectivity pattern, based on their type in the knowledge graph. For each type of hop node, there may be multiple relationship types that are provided for and presented as edges on the knowledge graph. These relationship types may be contextual in relation to the hop node types. Examples of relationships are described in the following sections.

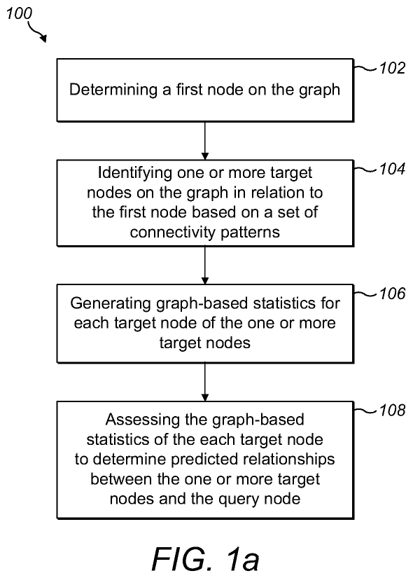

FIG. 1a is a flow diagram illustrating an example of a process 100 for querying a knowledge graph to assess relationships amongst graph nodes. The process 100 determines a query node and identifies one or more target nodes in relation to the query node. The relationship between each target node and the query node are assessed based on associated graph-based statistics. The steps of the process 100 are as follows:

In step 102, determining a query node on the graph. The determination may be made based on user preference and submitted in the form of a query. Such a query may include any of the herein described entities. Multiple queries may be conducted, or query nodes are selected or determined. In one example, the query node may be disease entities or data presentation of a certain disease or disease type.

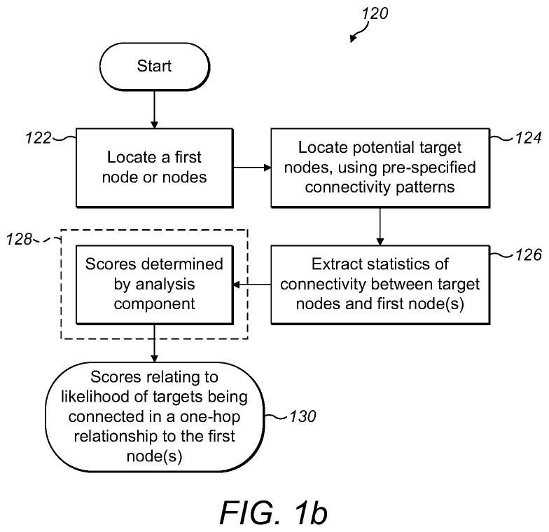

In step 104, identifying one or more target nodes on the graph in relation to the query node based on a set of connectivity patterns. The connectivity patterns may comprise one or more hop-length restrictions. For example, a hop-length restriction may be a two-hop. In the two-hop, a hop-length of two traversing any number of unique nodes between each target node and the query node are restricted for selecting the one or more target nodes. The hop-length may increase depending on the selection. The hop-length or hops are further illustrated in FIG. 2.

Additionally or alternatively, the connectivity patterns may comprise at least one path with zero or more intermediate nodes and/or one or more relationship types. The intermediate nodes may be a type of hop node where the types of hop node may include, by way of example in a biomedical application, but not limited to Pathway, Biological Process, Gene, Disease, Protein Family, Tissue, Compound, and Symptom. Some of these types and their associated relationships are shown in table 1 in the following section.

Additionally or alternatively, the connectivity patterns may be pre-specified based on one or more hop node types and/or one or more relationship types between two-hop nodes. For example, a pre-specification of all nodes associated with query-linked Pathway and/or Biological Process entities may be incorporated as the pattern of connectivity for selecting one or more target nodes. In this example, relationships associated with Pathway(s) such as DISEASE_TO_PATHWAY or IS_PARTICIPANT_IN may also be in included as part of the connectivity pattern.

In step 106, generating graph-based statistics for each target node of the one or more target nodes, where the graph-based statistics are extracted based on the subgraph associated with each target node and the query node. Each target node establishes a subgraph of the graph data structure in relation to the query node. The subgraph comprises one or more paths starting from the query node ending with the target node. Graph-based statistics may be extracted in relation to one or more paths associated with the subgraph. Various path types may exist amongst the one or more paths such that the one or more paths are associated with at least one hop node and/or hop node types. A path type may specify one or more relationships between the nodes that are traversed by the path.

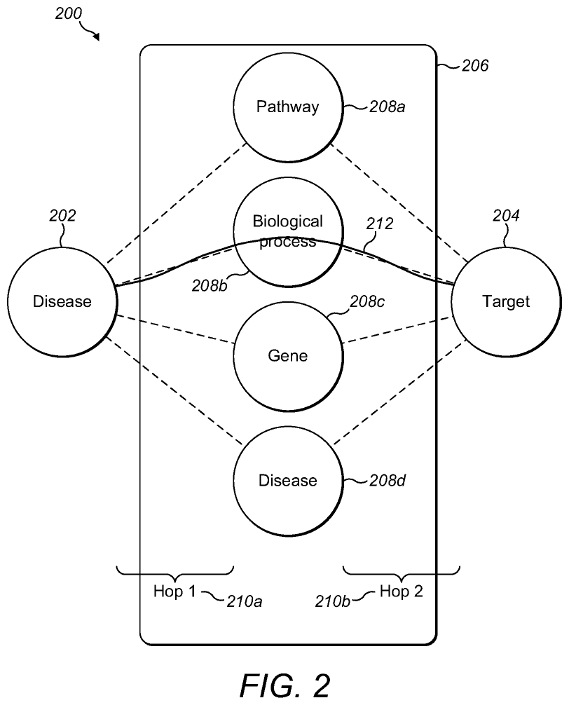

These graph-based statistics may include but are not limited to above-described examples with some further illustrated in FIG. 3. Graph-based statistics may be derived using a set of statistical tests. Examples of graph-based statistics may be the number of unique hop nodes, the number of unique paths from the query to the target node, and/or a number of unique edges in the subgraph connecting the query to the target node. The set of connectivity patterns may additionally or alternatively comprise the number of paths of a specific type connecting the target to the query node, in the biomedical context, the prediction of a disease-target link or relationship may be denoted contextually as “D-[disease-pathway_association]→P←[is_member_of_pathway]-T”, where D is the specific query disease, P is any pathway, and T is a candidate target, and the text in brackets is the relationship type in the graph.

Other examples of graph-based statistics may be derived using one or more algorithms or statistical tests. Statistical tests such as Fisher's extraction test may be applicable when considering the connectivity-adjusted measures based on the number of hop nodes connecting the target to the query node. In other cases, the use of the Adamic Adar index, preferential attachment, path counts, hop node counts, or other methods may be applicable and detail in the following sections.

Further examples of connectivity patterns may take into account the presence or absence of specific hop nodes deducible from such queries as “Is there a path of length <=3 that passes through the ‘PI3K signalling pathway’ entity?” This query and such may serve as potential connectivity patterns of the set of connectivity patterns under which the target nodes may be identified.

The extraction of graph-based statistics from a subgraph may be done manually or in an automated manner. Algorithms for traversing a graph data structure in either depth, breadth, or both may be applicable. The use of such algorithms may be combined with user-specified filters or constraints. The obtained graph-based statistics may be curated for inputting to the analysis component or a model for scoring in the following step.

In step 108, assessing the graph-based statistics of each target node to determine the likelihood of predicted relationships between the one or more target nodes and the query node. The likelihood of predicted relationships defines how realistic these relationships may be in relation to a set of scoring metrics. Assessment of graph-based statistics may begin by inputting the graph-based statistics to an analysis component. At the analysis component, graph-based statistics may be processed according to various transformations (e.g. odds ratio, −log 10p, and min, max, median, mean or a combination of such) and then fed into an ML approach in order to determine the final ranking/score. The analysis component may comprise one or more models for outputting at least one score associated with the graph-based statistics. The one or more models are configured to rank, rate, or otherwise examine each subgraph and associated statistics. Based on the set of scoring metrics, the analysis component outputs at least one corresponding score for each of the target nodes with respect to the subgraph.

The one or more models includes any generic set of models or functions. The models or functions are configured to provide scores, rank, rate, or otherwise examine each subgraph and associated statistics to assess the likelihood of a relationship of a pair of query-target entities on the knowledge graph. In one example, one or more ML models used for the combination of the graph-based statistics may be one or more ML models described in the sections above. In another example, a combination or ensemble of the ML models may be used. The models may be used in series as well in parallel. The ML models are trained on annotated data or datasets also described in the above sections, for example, a set of established disease-gene relationships. The selection of the one or more models may depend on the node queried initially. For instance, in the case of predicting disease-gene relationships, annotated data or dataset may be retrieved systemically from a structured database such as the Comparative Toxicogenomics Database (ctdbase.org) or DisGeNET (disgenet.org). The retrieved dataset may be data representations of a list of (disease, gene) pairs, or alternatively as a set of triples of the form (disease, confidence score, gene), or quads of the form (disease, relationship type, confidence score, gene).

A particular model may compute a likelihood score for each predicted relationship between the query and a target node based on a subgraph connecting the two nodes. Further computation is done to aggregate the likelihood scores across various hop node types such that an aggregate likelihood score for the types of hop nodes are derived. The aggregate likelihood score may be used to assess, based on the hop relationships, whether a relationship has a high likelihood. For instance, the determination of likelihood for a certain relationship or predicted relationships may depend on whether such a relationship is likely or unlikely in accordance with set criteria or threshold. The set criteria or threshold may be automatically determined in relation to, for example, an ML model described in the previous sections that are being used or set by users manually. Examples of these criteria or threshold may be any classification parameters of the ML model in relation to inputting graph-based statistics.

FIG. 1b is a flow diagram illustrating another example of a process 120 for querying a knowledge graph according to the invention. In this example, a connectivity pattern of one-hop is configured to determine suitable target nodes. Scores of the likelihood of these target nodes based on graph-based statistics provide the basis for assessing a predicted relationship or the likelihood of a predicted relationship between the first node and the target(s). The steps of process 120 are as follows:

In step 122, receiving or locate one or more first (query) nodes within a knowledge graph. The first node or nodes may be supplied by a user as one or more queries. By way of example, and in the context of biomedical data, this may represent a specific disease entity.

In step 124, the knowledge graph is then examined to determine possible target nodes connected to the first node. This examination may be constrained by way of example, by a one-hop pattern pre-specified by the user. The one-hop pattern specifies a single hop or hop-length of one between the first and target nodes. In addition or alternatively to the one-hop connectivity pattern, the first node may be connected to the target node by more than one intermediate node. In such case, the pattern is no longer limited to one-hop, but comprise any number of hops (i.e. n-hops) and the corresponding intermediate node(s). Alternatively or additionally, the intermediate node(s) between the first node and a target nodes may be further restricted by a specific type, or be connected by edges representing only specific relationships between the entities. For example, target nodes may be of a specific type: in a biomedical context, the target node may be of type Gene.

In step 126, the result of examining connections between the first node and target nodes may be a series of subgraphs. Each subgraph is associated with a target node and comprises paths from the first node to the target node. Following identification of these subgraphs, subject to the aforementioned constraints (connectivity patterns), graph-based statistics about each subgraph are generated or otherwise extracted. By way of example, this may include, but are not limited to quantitative measures of the connectivity of intermediate nodes, the number of unique paths in that subgraph connecting the first and target node(s), or graph-based statistics computed from those unique paths.

In step 128, the extracted graph-based statistics for each subgraph are then supplied to an analysis component that is configured to rank, rate, or otherwise examine each subgraph (or path therein) and associated graph-based statistics in order to determine whether it represents a likely (or ‘realistic’) relationship between the first node and the target(s). Numerous methods or algorithms may be employed at this stage, including any of the above described rule-based and/or ML models. ML models may be trained on annotated data such as, for example, direct links known between the first query and target nodes. An example of the annotated data includes known relationships of disease and gene as a list retrieved from one or more structured databases such as the Comparative Toxicogenomics Database (ctdbase.org) or DisGeNET (disgenet.org), and where the disease and gene may be represented either as a list of (disease, gene) pairs, or alternatively as a set of triples of the form (disease, confidence score, gene), or in some cases quads of the form (disease, relationship type, confidence score, gene).

Direct ‘known’ links may be identified and extracted when searching one or more text corpus, for example, when searching dictionaries or repositories associated with one or more domains of interest. A repository may include a pair of entities and their direct relationship or link herein described as ‘known’. Methods for extracting the link or a data representation thereof may comprise any of the data mining techniques or algorithms to the extent beyond the scope of this application.

In step 130, the scores, rankings, or other classification of the relationships through the knowledge graph are output to the user. These scores may represent a combined likelihood of whether a new knowledge graph relationship (directly between the first node and one of the target nodes) can be inferred based on the data encoded within the knowledge graph. In a biomedical context, a likelihood of a predicted relationship determination may be tantamount to determining that there is a likely biological mechanism connecting the first node—for example a disease—with a target (for instance a gene): an inference that may be useful in determining potential new drug treatments for the disease itself.

In an example pertaining to FIGS. 1a and 1b, relevant genes that are responsible for (or otherwise linked directly to) the presence of a disease can be identified and verified. To arrive at this assessment, the type of query forming the input to stages associated with steps 102 or 122 may be a query of type Disease (or disease node) and target nodes of type Gene, and connectivity pattern(s) being no more than one intermediate node per path representing biological mechanisms, yielding a subgraph which may contain both one-hop and two-hop connections between the query disease and each among one or multiple genes. Other examples of first node types, target node types, and connectivity patterns may be additionally or alternatively be constrained.

Other examples of connectivity patterns may include, but are not limited to hop-length restrictions, relationship types, limitations on the numbers of paths through the graph from the first node to a given target, confidence scores (for instance minimum confidence thresholds), the connectivity of intermediate nodes, or other constraints. These connectivity patterns may be additionally or alternatively applied to the knowledge graph to identify the suitable target nodes.

From the above example, the analysis component may be a trained ML model configured to accept inputs of graph-based statistics from one or more paths through the knowledge graph from a first node to one or more target nodes, and return a score or decision on whether the path through the knowledge graph is predictive of a direct link between the first node and target node. In the context of a biomedical application of the invention, a correctly identified a direct link may be one where an inferred connection between a first disease-node and a target gene-node is representative of an actual causal connection between the two.

The output of the above trained ML model may be in the form of a score for each target, representative of a confidence level or likelihood of predicted relationship, or a binary classification for each target (namely that it is ‘likely’ or ‘unlikely, for instance, according to a pre-specified confidence threshold). The target-level scores may or may not be comprised of an aggregation of path-level scores (e.g. distinguishing paths through various hop node types). Other methods of ranking, prioritising, labelling or otherwise scoring the targets (or paths) may be implemented, as will be appreciated by those skilled in this technical field.

The way in which connectivity statistics may influence the score or ranking of a particular path through the knowledge graph, is that a path with intermediate nodes of high-connectivity may be given a comparably lower score than one with sparsely connected intermediate nodes, on the basis that highly-connected intermediate nodes are less statistically interesting, or may lead to less-specific target node connections, relative to those connected via hop nodes with fewer connections.

FIG. 2 is a schematic diagram 200 illustrating an example of a target node 204 queried based on connectivity patterns 206 according to the invention. Starting from a disease query node 202, a two-hop as part of the connectivity patterns 206 is shown for identifying a target node 204. The two-hop comprise a first hop 210a and a second hop 201b. Each hop traverses one or more unique nodes before reaching an intermediate node or a target node. These unique nodes form hop-node specific paths (two-hop paths) combined to form subgraphs. In this figure, various types of intermediate nodes are shown. These nodes may be considered hop nodes in relation to the hop paths. The types of hop nodes, in this case, are Pathway 208a, Biological Process 208b, Disease 208c, and Gene 208d. The types of hop nodes and their associated relationships (not shown in the figure) from a particular instantiation are depicted in table 1 below.

TABLE 1

| Hop node type | Relationship types used for hop 1 | Relationship types used for hop 2 |
|---|---|---|
| Pathway | DISEASE_TO_PATHWAY | IS_PARTICIPANT_IN |
| Biological | DISEASE_TO_BIOPROCESS | IS_PARTICIPANT_IN |
| Process | | |
| Gene | GENETIC_ASSOCIATION, | GENE_GENE_INTERACTION |
| | TRANSCRIPTOMIC_ASSOCIATION | |
| Disease | IS_TYPE_OF, IS_RELATED_TO | GENETIC_ASSOCIATION, |
| | | TRANSCRIPTOMIC_ASSOCIATION |

Further in FIG. 2, the connectivity patterns may also include Biological Process 208b type hop node to the extent that only include paths traversing the Biological Process nodes may be part of the resultant subgraph. Alternatively or additionally, the connectivity patterns may also include relationship types as depicted in table 1 above. The relationships types may be associated with a particular hop node type or types as illustrated in the above table.

The relationships associated with the hop node type may be extracted from processing one or more text corpus in the relevant scientific fields or domains of interest. The extraction may be accompanied by Natural Language Processing or other methods for analysing text. Techniques such as Name Entity Recognition may be applicable. Alterative rule-based extraction methods may also use for classification of these relationships. However, how these relationships may be obtained is beyond the scope of this application.

FIG. 3 is a schematic diagram 300 illustrating an example of extracted graph-based statistics 302 as inputs to the analysis component 304 to be scored according to the invention. Likelihood score 306 based on the extracted graph-based statistics 302 of a likely relationship may be computed using, for example, a score function or one or more rule-based and/or ML models described herein. For example, the graph-based statistics or the underlying metrics include, but are not limited to the total number of node counts, the count of unique nodes mediating each target's connection to the disease/query node, and the total number of edge counts, the number of unique edges along paths from the query node to each target. The metrics may be specificity-related calculations computed in the form of, for example, odds ratios or p-values via Fisher's exact tests of node count or relationship counts, as described in more detail below. Additionally or alternatively, statistical significance tests such as Fisher's exact tests may be performed for each hop node type, as well as calculations aggregated across node type as shown, for example, in FIG. 3 as pathway_neg_log10_adjp.

In one example, Fishers exact test is applied as follows: for each hop node type, the Fisher's exact test may be performed according to the following inputs: (i) the total number of nodes of this type, (ii) the number of such nodes connected to the disease, and (iii) the number of such nodes connected to the target, and (iv) the number of nodes connected to both the disease and the target. Further to this example, the calculation uses Pathway as the hop node type. For a given disease D and gene G, if one defines N to refer to the total number of Pathway nodes in the graph, N_{D} as the number of Pathway nodes that are connected to D, N_{G} as the number of Pathway nodes connected to G, and N_{DG} as the number connected to both, one can compute the following quantities: a=N_{DG}; b=N_{D}−a; c=N_{G}−a, and d=N−(a+b+c). Then the Fisher's exact test can be applied using these four quantities in a Fisher's exact contingency table, where a and b fill the first row respectively from left to right, and c and d fill the second row respectively. This test yields a p-value and odds ratio, and by repeating this process for each hop node type, one can obtain metrics indicative of the specificity or strength of the connection between each pair of D and T nodes.

In another example, graph-based statistics may additionally or alternatively include, but are not limited to Raw Node IDs, Adamic Adar, Common Neighbours, and Preferential Attachment and described below. These graph-based statistics may be combined with other statistics such as for each hop-node type. The curated subset of hop node types (Diseases, Pathways, and Biological Processes, and Targets) for a particular relationship is shown in FIG. 3.

Raw Node IDs: for type m, the feature is an indicator vector of length Nm, the number of distinct nodes of type m in the graph. For the pair (x,y) this indicator is given component-wise as:

( [symbol] )i=Aₓᵢ^{r}

[symbol]

where A^{r} is the adjacency matrix for relations of type (Disease, m), i.e. the first hop, and A^{p} is the adjacency matrix for relations of type (m, Target), i.e. the second hop.

Adamic Adar is the inverse logarithmic degree of centrality of the neighbours shared by two nodes of a graph. Adamic Adar produces a positive (unbounded) score S with low scores indicating low similarity, high scores higher similarity to which is defined as:

$${S}_{rp} ( x , ) = {\sum }_{u ∈ ( x ) ⋂ ( y )} \frac{1}{log \vert ( u ) \vert log \vert ( u ) \vert}$$

and may be applicable for common elements with very large neighborhoods are lesser significant when predicting a connection between two nodes compared with elements shared between a small number of nodes. This version of Adamic Adar has been adapted to the two-hop scenario where relationship types (represented here by r and p) may be different for different hops in the connectivity pattern. This can easily be extended via additional hops by incorporating additional terms in the denominator.

Common Neighbours: captures the idea that (Disease, Target) pairs which share many neighbours are more likely to exist in the benchmark:

Sᵣₚ(x, [symbol] )=| [symbol] (x)∩ [symbol] ( [symbol] )|

Preferential Attachment: in general, we may expect the more connected a node is, the more likely it is to receive new links:

Sᵣₚ(x, [symbol] )=| [symbol] (x)|×| [symbol] ( [symbol] )|

The graph-based statistics are assessed to determine predicted relationships or the likelihood of predicated relationships between the one or more target nodes and the query node. Graph-based statistics are inputted to an analysis component, where the scoring of the graph-based statistics based on a set of metrics begins to compute, in this case, likelihood score resulting from the graph-based statistics. Various metrics for ranking or scoring may be used for determining the likelihood score, for example, using one or more rule-based and/or ML models herein described.

Further, in FIG. 3, the likelihood score may be an aggregate score across hop node types, for example, by using metrics such as median (odds ratio), mean (−log 10p), or amongst any combinations of (min, max, median, mean) and (odds ratio, −log 10p) to determine a ranking of target nodes. The Individual metrics may additionally or alternatively be considered prior to aggregation for determination of the ranking. The output of the at least one corresponding score for each of the target nodes with respect to the subgraph may be a particular combination of above methods as shown in the figure. Additionally or alternatively, not shown in the figure, one or more ML models described herein could be configured to aggregate optimally the likelihood scores associated with extracted graph-based statistics 302. For example, the input to an ML model may be a set of likelihood score for each target where the ML model is configured to combine these different scores based on a set of embedded classification criteria.

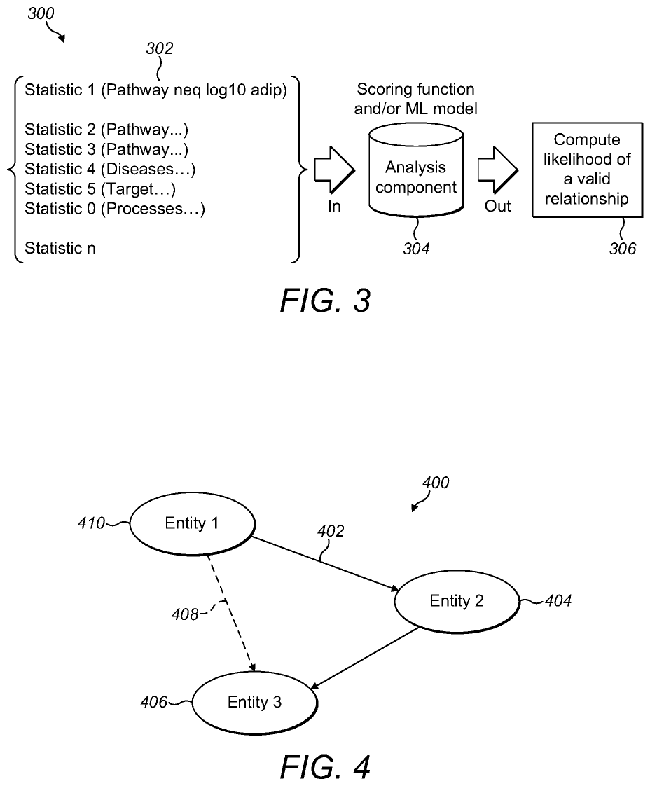

FIG. 4 is a schematic diagram of an example (a portion of) a knowledge graph 400 or subgraph that may be used by the process of FIG. 1a or 1b according to the invention. The knowledge graph 400 includes a plurality of nodes 404, 406 and 410 (also referred to herein as entity nodes) connected with one or more other nodes to a plurality of edges 402, 408, and 412. The plurality of nodes 404, 406 and 410 represent entities (e.g. Entity 1, Entity 2, Entity 3), which may be, without limitation, for example biological entities and the like, and the plurality of edges 402, 408, and 412 represent relationships that connect the nodes 404, 406 and 410. Each of the edges 402 and 408 may represent a relationship that associates a node of the plurality of nodes 404, 406 and 410 with another of the plurality of nodes 402, 408, and 412. Note, it is also possible to have knowledge graphs in which a node is self-connected by an edge, i.e. an edge that loops back to connect with the same node. Each of the edges 402, 408, and 412 may include further attributes associated with the relationship such as, without limitation, for example directionality, labelling, confidence score of the relationship, and any other useful information associated with the relationship and the like etc. In this example, a first entity node 410 representing a first entity, e.g. Entity 1, is linked via a first edge 402 to a second entity node 404 representing a second entity, e.g. Entity 2, where the first edge 402 is labelled, without limitation, for example with data representing the form of the relationship that exists between the first and second entities, e.g. Entity 1 and Entity 2, of the first and second entity nodes 404 and 406, respectively. For example, in the biomedical domain, the first entity (e.g. Entity 1) of the first entity node 410 may be a gene and the second entity (e.g. Entity 2) of the second entity node 404 may be a disease. Thus, the edge 402 between the first and second entity nodes 410 and 404 may be configured, in this example, to represent a gene-disease relationship, which, without limitation, for example may be tantamount to “causes” if the gene (Entity 1) of the first entity node 410 is responsible for the presence of the disease (Entity 2) of the second entity node 404.

Expanding on this example, the third entity may also be a disease in which shared a disease-disease relationship exists over edge 412 with the second entity. A trained ML model may be configured to examine the knowledge graph and infer new gene-disease relationships to the extent on receiving data representative of a portion or subset of the knowledge graph representing nodes 404, 406 and 410 connected with edges 402 and 412, and based on the connectivity patterns infer or predict a new gene-disease relationship represented by dashed edge 408 between the first entity and the third entity. The new edge 408 may be inferred and incorporated as part of a path forming a subgraph that identifies a potential target node. However, these new inferences may not always prove to be correct, thus, as detailed above, an ML model process the graph-based statistics of various subgraphs to compute scores, when compared to a benchmark dataset or based on one or more criteria determined whether the relationship between the target and the query node may be likely or realistic with high probability.

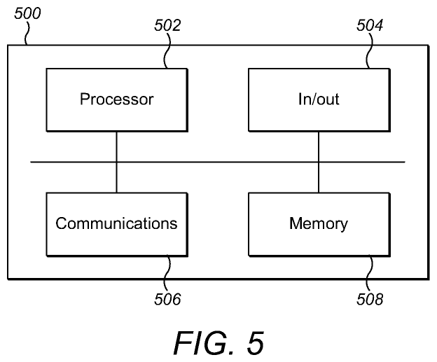

FIG. 5 is a schematic diagram illustrating an example computing apparatus/system 500 that may be used to implement one or more aspects of the data configuration system(s), apparatus, method(s), and/or process(es) combinations thereof, modifications thereof, and/or as described with reference to FIGS. 1a to 4 and/or as described herein. Computing apparatus/system 500 includes one or more processor unit(s) 502, an input/output unit 504, communications unit/interface 506, a memory unit 508 in which the one or more processor unit(s) 502 are connected to the input/output unit 504, communications unit/interface 506, and the memory unit 508. In some embodiments, the computing apparatus/system 500 may be a server, or one or more servers networked together. In some embodiments, the computing apparatus/system 500 may be a computer or supercomputer/processing facility or hardware/software suitable for processing or performing the one or more aspects of the data configuration system(s), apparatus, method(s), and/or process(es) combinations thereof, modifications thereof, and/or as described with reference to FIGS. 1a to 4 and/or as described herein. The communications interface 506 may connect the computing apparatus/system 500, via a communication network, with one or more services, devices, the server system(s), cloud-based platforms, systems for implementing subject-matter databases and/or knowledge graphs for implementing the invention as described herein. The memory unit 508 may store one or more program instructions, code or components such as, by way of example only but not limited to, an operating system and/or code/component(s) associated with the process(es)/method(s) as described with reference to FIGS. 1a to 4, additional data, applications, application firmware/software and/or further program instructions, code and/or components associated with implementing the functionality and/or one or more function(s) or functionality associated with one or more of the method(s) and/or process(es) of the device, service and/or server(s) hosting the configuration process(es)/method(s)/system(s), apparatus, mechanisms and/or system(s)/platforms/architectures for implementing the invention as described herein, combinations thereof, modifications thereof, and/or as described with reference to at least one of the figure(s) 1a to 4.

In relation to any of above-described process(es)/method(s) with reference to FIGS. 1a to 4, a scaffold query tool suitable for use with the example of computing apparatus described in FIG. 5 is configured to assess relationships amongst the graph nodes by way of utilising an input component, a query component, an extraction component, and an analysis component. The input component is configured to receive the graph, and a query node on the graph and together with a set of connectivity patterns. From the query node, one or more target nodes are identified on the graph by the query component based on the set of connectivity patterns. A subgraph is formed associated with each of the target nodes, where the subgraph comprises multiple paths stemming from the query node to a target node. The extraction component is configured to extract graph-based statistics of a particular subgraph, and the likelihood of predicted relationships between the one or more target nodes and the query node in relation to the subgraph are assessed by the analysis component. The scaffold query tool may apply additionally or alternatively any of the herein described process(es)/method(s) or modules(s)/component(s).

In an aspect associated with FIGS. 1a to 4, a computer-implemented method of querying a graph to assess relationships amongst graph nodes comprising: determining a query node on the graph; identifying one or more target nodes on the graph in relation to the query node based on a set of connectivity patterns; generating graph-based statistics for each target node of the one or more target nodes, wherein the graph-based statistics are extracted for subgraphs associated with each target node and the query node; and assessing the graph-based statistics of each target node to determine predicted relationships between the one or more target nodes and the query node.

In another aspect, a computer-readable medium storing code that, when executed by a computer, causes the computer to perform any method optionally described below.

In yet another aspect, a system for querying a graph to assess relationships amongst the graph nodes, the system comprising: an identification module configured to identify one or more target nodes in relation to a query node based on a set of connectivity patterns; a processing module configured to generate a graph-based statistics for each target node of the one or more target nodes, wherein the graph-based statistics are extracted for subgraph associated with each target node and the query node; and an evaluation module configured to assess the graph-based statistics of each target node to determine predicted relationships between the one or more target nodes and the query node. Optionally, the system may be adapted or configured to implement any of the methods as optionally described below. Optionally, evaluation module of the system further comprise an analysis component in accordance with a set of metrics configured to score the graph-based statistics for each target node using one or more models.

In yet another aspect, a scaffold query tool for querying a graph to assess relationships amongst the graph nodes, the scaffold query tool comprising: an input component configured to receive the graph, and a query node on the graph and a set of connectivity patterns; a query component configured to identify one or more target nodes on the graph in relation to the query node based on a set of connectivity patterns an extraction component configured to extract graph-based statistics of a subgraph associated with each target node and the query node; and an analysis component configured to assess the graph-based statistics to determine predicted relationships between the one or more target nodes and the query node. Optionally, the scaffold query tool may be adapted or configured to implement any of the methods as optionally described below.

Optionally, assessing the graph-based statistics of each target node to determine predicted relationships between the one or more target nodes and the query node further comprising: inputting the graph-based statistics to an analysis component; scoring the graph-based statistics using the analysis component in accordance with a set of metrics, wherein the analysis component comprises one or more models for outputting at least one score associated with the graph-based statistics; and outputting the at least one corresponding score for each of the target nodes with respect to the subgraph.

Optionally, computing a likelihood score to assess the predicted relationships between the query and a target node of the one or more target nodes, wherein the likelihood score are aggregated across various hop node types.

Optionally, the one or more models comprise at least one machine learning model.

Optionally, the at least one machine learning model is trained on annotated data.

Optionally, the annotated data comprise known data of related diseases and genes.

Optionally, the connectivity patterns comprise one or more hop-length restrictions.

Optionally, the connectivity patterns further comprise at least one path with one or more intermediate nodes and/or at least path with a relationship type associated with at least one intermediate node.

Optionally, one or more intermediate node is a type of hop node.

Optionally, the one or more connectivity patterns are pre-specified based on one or more hop node types and/or one or more relationship types between two hop nodes.

Optionally, the query node corresponds to a disease entity.

Optionally, the graph-based statistics are extracted in relation to one or more paths associated with the subgraph.

Optionally, the one or more paths each comprising a path type specifying one or more relationships between the nodes traversed by each path.

Optionally, the one or more paths are associated with at least one hop node and/or hop node types.

Optionally, the graph-based statistics are derived using a set of statistical tests.

In the embodiments, examples, and aspects of the invention as described above such as process(es), method(s), system(s) and/or tool for querying a graph data structure may be implemented on and/or comprise one or more cloud platforms, one or more server(s) or computing system(s) or device(s). A server may comprise a single server or network of servers, the cloud platform may include a plurality of servers or network of servers. In some examples the functionality of the server and/or cloud platform may be provided by a network of servers distributed across a geographical area, such as a worldwide distributed network of servers, and a user may be connected to an appropriate one of the network of servers based upon a user location and the like.

The above description discusses embodiments of the invention with reference to a single user for clarity. It will be understood that in practice the system may be shared by a plurality of users, and possibly by a very large number of users simultaneously.

The embodiments described above may be configured to be semi-automatic and/or are configured to be fully automatic. In some examples a user or operator of the querying system(s)/process(es)/method(s) may manually instruct some steps of the process(es)/method(es) to be carried out.

The described embodiments of the invention a system, process(es), method(s) and/or tool for querying a graph data structure and the like according to the invention and/or as herein described may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the process/method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium or non-transitory computer-readable medium. Computer-readable media may include, for example, computer-readable storage media. Computer-readable storage media may include volatile or non-volatile, removable or non-removable media implemented in any method or technology for storage of information such as computer-readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection or coupling, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, IoT devices, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary”, “example” or “embodiment” is intended to mean “serving as an illustration or example of something”. Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art.

What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A computer-implemented method of querying a graph to assess relationships amongst graph nodes comprising:
determining a query node on the graph;
identifying one or more target nodes on the graph in relation to the query node based on a set of connectivity patterns;
generating graph-based statistics for each target node of the one or more target nodes, wherein the graph-based statistics are extracted for subgraphs associated with each target node and the query node; and
assessing the graph-based statistics of each target node to determine predicted relationships between the one or more target nodes and the query node.

2. The computer-implemented method of claim 1, wherein assessing the graph-based statistics of each target node to determine predicted relationships between the one or more target nodes and the query node further comprises:
inputting the graph-based statistics to an analysis component;
scoring the graph-based statistics using the analysis component in accordance with a set of metrics, wherein the analysis component comprises one or more models for outputting at least one score associated with the graph-based statistics; and
outputting the at least one corresponding score for each target node of the one or more target nodes with respect to the subgraph.

3. The computer-implemented of claim 1, further comprising:
computing a likelihood score to assess the predicted relationships between the query and each target node of the one or more target nodes, wherein the likelihood scores are aggregated across various hop node types.

4. The computer-implemented of claim 2, wherein the one or more models comprise at least one machine learning model.

5. The computer-implemented of claim 4, wherein the at least one machine learning model is trained on annotated data comprising known data of related diseases and genes.

6. (canceled)

7. The computer-implemented of claim 1, wherein the connectivity patterns comprise one or more hop-length restrictions.

8. The computer-implemented of claim 1, wherein the connectivity patterns further comprise at least one path with one or more intermediate nodes and/or at least path with a relationship type associated with at least one intermediate node.

9. The computer-implemented of claim 8, wherein, the one or more intermediate nodes are a type of hop node.

10. The computer-implemented of claim 1, wherein the one or more connectivity patterns are pre-specified based on one or more hop node types and/or one or more relationship types between two hop nodes.

11. The computer-implemented of claim 1, wherein the query node corresponds to a disease entity.

12. The computer-implemented of claim 1, wherein the graph-based statistics are extracted in relation to one or more paths associated with the subgraph.

13. The computer-implemented of claim 12, wherein the one or more paths each comprising a path type specifying one or more relationships between the nodes traversed by each path.

14. The computer-implemented of claim 12, wherein the one or more paths are associated with at least one hop node and/or hop node types.

15. The method of claim 12, wherein the graph-based statistics are derived using a set of statistical tests.

16. A computer-readable medium storing code that, when executed by a computer, causes the computer to perform the computer-implemented method of claim 1.

17. A system for querying a graph to assess relationships amongst graph nodes, the system comprising:
an identification module configured to identify one or more target nodes in relation to a query node based on a set of connectivity patterns;
a processing module configured to generate graph-based statistics for each target node of the one or more target nodes, wherein the graph-based statistics are extracted for subgraph associated with each target node and the query node; and
an evaluation module configured to assess the graph-based statistics of each target node to determine predicted relationships between the one or more target nodes and the query node.

18. The system of claim 17, wherein the evaluation module further comprises an analysis component in accordance with a set of metrics configured to score the graph-based statistics for each target node using one or more models.

19. The system of claim 17, wherein the system is configured to query a graph to assess relationships amongst graph nodes by:
determining a query node on the graph;
identifying one or more target nodes on the graph in relation to the query node based on a set of connectivity patterns;
generating graph-based statistics for each target node of the one or more target nodes, wherein the graph-based statistics are extracted for subgraphs associated with each target node and the query node; and
assessing the graph-based statistics of each target node to determine predicted relationships between the one or more target nodes and the query node,
wherein assessing the graph-based statistics of each target node to determine predicted relationships between the one or more target nodes and the query node further comprises:
inputting the graph-based statistics to an analysis component;
scoring the graph-based statistics using the analysis component in accordance with a set of metrics, wherein the analysis component comprises one or more models for outputting at least one score associated with the graph-based statistics; and
outputting the at least one corresponding score for each target node of the one or more target nodes with respect to the subgraph.

20. A scaffold query tool for querying a graph to assess relationships amongst graph nodes, the scaffold query tool comprising:
an input component configured to receive the graph, and a query node on the graph and a set of connectivity patterns;
a query component configured to identify one or more target nodes on the graph in relation to the query node based on a set of connectivity patterns;
an extraction component configured to extract graph-based statistics of a subgraph associated with each target node and the query node; and
an analysis component configured to assess the graph-based statistics to determine predicted relationships between the one or more target nodes and the query node.

21. The scaffold query tool of claim 20, further configured to query a graph to assess relationships amongst the graph nodes by:
determining a query node on the graph;
identifying one or more target nodes on the graph in relation to the query node based on a set of connectivity patterns;
generating graph-based statistics for each target node of the one or more target nodes, wherein the graph-based statistics are extracted for subgraphs associated with each target node and the query node; and
assessing the graph-based statistics of each target node to determine predicted relationships between the one or more target nodes and the query node,
wherein assessing the graph-based statistics of each target node to determine predicted relationships between the one or more target nodes and the query node further comprises:
inputting the graph-based statistics to an analysis component;
scoring the graph-based statistics using the analysis component in accordance with a set of metrics, wherein the analysis component comprises one or more models for outputting at least one score associated with the graph-based statistics; and
outputting the at least one corresponding score for each target node of the one or more target nodes with respect to the subgraph.
